(19) United States
(12) Patent Application Publication
(10) Pub. No.: US 2018/0133946 A1
(43) Pub. Date: May 17, 2018

(54) INSTALLATION FOR PRODUCING A FILM WEB AND METHOD FOR OPERATING SUCH AN INSTALLATION

(71) Applicant: REIFENHÄUSER GMBH & CO. KG MASCHINENFABRIK, Troisdorf (DE)

(72) Inventors: Andreas NEUSS, Worms (DE); Armin HOLIGHAUS, Troisdorf (DE); Paul WALACH, Troisdorf (DE)

(21) Appl. No.: 15/558,149

(22) PCT Filed: Apr. 21, 2016
(86) PCT No.: PCT/DE2016/000168

§ 371 Date: Sep. 13, 2017

(30) Foreign Application Priority Data
Jun. 3, 2015 (DE) 10 2015 006 891.1

(51) Int. Cl. B29C 47/00; B29C 47/92; B29C 55/06; B29C 55/28; G01B 11/30; G01N 21/89

(52) U.S. Cl. CPC B29C 47/0059; B29C 47/92; B29C 55/06; B29C 55/28; G01B 11/306; G01N 21/8914; B29C 47/0898; B29C 47/0026; B29C 47/0057; B29C 2947/92152; B29C 2947/92438; B29C 2947/92647; B29C 47/0021

(57) ABSTRACT

An installation for producing a film web and a method for operating such an installation includes a control circuit having a controller, a sensor and an actuator integrated into the ongoing film production process. The sensor is set up to sense a flatness of the film web, and the sensor is data-connected to the controller, wherein the controller is data-connected to the actuator and the actuator is actuated by the controller in order to control film production on the basis of the flatness.

### TECHNICAL FIELD

The disclosure refers to an installation for producing a film web and to a method for operating such an installation.

### BACKGROUND

In particular, the disclosure refers to a plant and a method in which the thermoplastic is extruded in at least one layer as a plastic melt in one extrusion direction by a ring-shaped die or a flat-film die and is then guided over at least one roller, with tensile forces being exerted in the extrusion direction and/or transversely to the extrusion direction; or subsequently, but before a winder, in the machine direction and/or transversely to the machine direction, in order to stretch or draw the film web longitudinally and/or transversely.

In the production of film webs from thermoplastics by means of extrusion of a melt, substantially two methods are distinguished; one is the production of a flat film by a flat-film die; the other is the production of blown film by a ring-shaped die.

During flat-film production by means of a flat-film die, the melt issuing from the flat-film die is drawn out to a specific thickness by means of a cooling roll or a chill roll and is cooled off. During this process, transparency, gloss and some mechanical properties of the film are heavily influenced. Typically, the polymer chains of the obtained film web are oriented in the extruding direction, which leads to anisotropic properties of the film web. Corresponding methods are known, for instance, from EP 0 319 401 B1, from U.S. Pat. No. 5,709,932, from US 2007/0267774 A1 or from EP 1 900 498 A1. In contrast, EP 2 559 546 A1 by the present applicant discloses a method by means of which the properties of the film can be approximated to those of a film coming from a blown-film plant.

Other than with a flat-film die, the melt is drawn in the longitudinal and transverse directions over the tube forming zone with the blown-film method; that is, with the extrusion of a plastic melt issuing from a ring-shaped die and subsequently formed to a tubing. This takes place above the melting range of the extruded polymers, i. e. in the molten form. The film is drawn off an outlet faster than it is extruded, which causes the film to be stretched in the longitudinal direction. By inflation, the film is additionally stretched in the transverse direction. This results in a biaxially stretched film which, however, exhibits drawbacks in comparison to the flat film because of a lesser degree of cooling; for example in terms of the optical properties.

WO 2014/023282 A1 by the present applicant in contrast discloses a method by means of which the flatness or other properties of the blown film can be substantially improved by stretching or drawing.

The present disclosure is based on the task of improving the state of the art or of offering an alternative to the same.

### SUMMARY

In a first aspect of the present disclosure, the task is solved by an installation for producing a film web, by means of a die, from a plastic melt provided by an extruder, and for winding up the film web to a film roll by means of a winder; the installation being adapted to guide the film web, in its path along a machine direction from the die to the winder, over a guide roller and to finally wind it up onto the film roll by means of the winder; the installation having a control circuit with a controller, a sensor and an actuator; the sensor being adapted to determine a measure for the flatness of the film web; the controller being adapted to actuate the actuator using the measure of the flatness so as to improve the flatness of the film web.

Some terminology will be explained in the following:

First, it is explicitly pointed out that within the framework of the present patent application, indefinite articles and numerals such as “one”, “two” etc. are usually to be understood as indicating a minimum, that is, “at least one . . . ”, “at least two . . . ” etc., unless it explicitly becomes clear from the context or is obvious to the person skilled in the art or technically mandatory that only “exactly one . . . ”, “exactly two . . . ” etc. can be intended.

The “film web” can either be a one-layered film web or a tubular film web, where the tube can be cut or be left tubular.

The “die” is preferably a flat-film die or a ring-shaped die. If a ring-shaped die is provided, it is proposed to arrange the same at a blowing head.

The film web can be one-layered or multi-layered. In particular, therefore, it is possible to provide more than one extruder.

It is also possible to provide not only one winder, but a plurality of winders.

The “machine direction” is the designated path of the film, starting with extrusion at the die and ending at the winder. The machine direction can therefore vary, for the path runs over a plurality of rollers and possibly also over turning bars.

Errors in “flatness” can be, in particular, films which sag when not under tension, and/or a curvature of the film web. Thus, there can be films with an ideally constant thickness which nevertheless have a flatness error; and there can be films with deviations in thickness which nevertheless have an ideal flatness.

A flatness error is caused by locally varying lengths of the film web.

It has surprisingly been found by the inventors that a flatness error can be corrected nearly independently of other film quality errors. The first aspect of the disclosure therefore provides, in simple words, for controlling a film-production plant in terms of flatness as well.

Trials performed by the inventors have demonstrated a great potential of doing this. The inventors believe that this is due to the fact that even small corrections in the internal distribution of film-web length lead to substantial improvements in flatness. Even with only 1% to 3% longitudinal stretching of the film web, the trials have shown the shorter strips to have been drawn at least substantially to the length of the originally longer strips.

It can be provided for the installation to have a second control circuit with a sensor adapted to determine a measure of a deviation of the thickness profile and with a controller adapted to actuate an actuator depending on the measure of the deviation of the thickness profile in order to improve the deviation of the thickness profile.

It is explicitly pointed out that the sensor and/or the controller and/or the actuator can be identical to those of the control circuit according to the first aspect of the disclosure. They are merely termed “second” for formal purposes.

It is deemed optimal by the inventors if such a control circuit is provided for the thickness profile, in addition to the proposed control circuit for the flatness.

As far as possible, the control of the thickness profile should influence only the thickness profile, and the control of the flatness error should influence only the flatness.

The controller can be data-connected to the actuator. Thus, the actuator can be electronically actuated, and a computing unit in the actuator evaluates the data and performs the actuation accordingly.

The controller can be connected to the actuator by way of the motor current. Thus, the actuator can be electrically actuated, and the controller performs the actuation.

Alternatively, other types of drive for the actuator can be provided, for instance a hydraulic drive.

Preferably, the actuator is adapted to actuate a heating means and/or a longitudinal stretching device on the path leading from the die to the winder.

The means for influencing the film web, which are actuated by the actuator, for instance, a heating means and/or a longitudinal stretching unit, are suitable for directly influencing the flatness characteristics of the film web already during production. In this way, the flatness of the film web on the winder can be optimized during the production process, even, if the control circuit has been adjusted adequately, without human intervention. Instead, the installation can be able to optimize the flatness autonomously.

A specific embodiment of the disclosure provides for the sensor to be adapted to register a roll-off edge of the film web on the guide roller, the sensor being data-connected to the controller.

The “roll-off edges” of the film web on the guide roller which the sensor is adapted to record, is the line along which the film detaches itself from the surface of the guide roller. The roll-off edge and the detection thereof are described in detail in WO 2007/107147 A1.

The controller registers the deviations of the roll-off edge from an ideal, straight line parallel to the guide roller axis as a measure of a flatness error in the moving film web.

Whenever a deflection of the roll-off edge indicates an undesired flatness deviation during ongoing film web production, the controller therefore actuates the actuator such that the site recognized as being faulty is corrected. The site located in the circumference of the film web, or the site located in the width of the film web, can, for instance, be heated with a heating means, which leads to a stronger extrusion, and/or the site can be stretched or drawn more strongly in a longitudinal stretching unit, or other measures can be taken, for instance the cooling, the geometry of a die lip etc. can be influenced.

In one variant of the installation proposed here, the installation is a blown-film plant, the die is a ring-shaped die and a lay-flat device and a take-off unit and possibly a reversing unit are provided in the path leading from the ring-shaped die to the winder.

Here as well, deviations in the film profile, caused by extrusion or by heterogeneous cooling in the lay-flat device, are possible which lead to the flatness errors. These have negative effects on further processing of the produced film web, on the film rolling result etc.

The closer the sensor is to the winder, the more precise are the measurement results in terms of thickness deviation of the film, that is, in terms of a possible flatness error. It is therefore proposed to arrange the sensor in the path from the ring-shaped die to the winder externally to the lay-flat device, in particular externally to the take-off unit, preferably even at one of the last two or three guide rollers before the winder, particularly preferably at the last guide roller before the winder, wherein the guide roller can even be part of the winder.

A particularly preferred embodiment of the disclosure provides for arranging a longitudinal stretching unit in the path from the ring-shaped die to the winder between the take-off unit and the sensor, or between the sensor and the winder.

In particular, as a longitudinal stretching unit, an installation unit is suitable which can correct flatness errors by longitudinal stretching, for which purpose the temperature of the film web is increased to a defined value, particularly in the take-off unit, and the film web is subjected to slight stretching, preferably between 1% and 4%.

For the design of the longitudinal stretching unit, in particular the disclosure of WO 2014/023282 A1 by the same applicant is mentioned, which is to be considered as incorporated in its entirety by reference.

Thereby, the curvature of the film, the curling tendency and other film deficiencies can be reduced or even completely eliminated.

An alternative provides for the installation being embodied as a flat-film plant, with the die being a flat-film die and a chill roll being arranged first in the path from the flat-film die to the winder, the flat-film die extruding onto the chill roll.

The stronger the adhesion of the transferred and deviated film to the surface of a guide roller, the higher the amplitude of deviations of the roll-off edge from the ideal line parallel to the guide roller axis.

It is therefore proposed to provide in the machine direction before the sensor, preferably directly before the sensor, that is, not before a guide roller which precedes the sensor in the machine direction, a charging unit for introducing an electrostatic charge between the film web and the guide roller so that when the charging device is switched on during operation of the plant, the roll-off edge of the film web moves downwards the guide roller and thus varies in height.

This applies independently of the type of film-manufacturing plant.

For applying an electrical charge, a brush can be provided, for instance, or an electrical connector can apply a voltage to the surface of the roller with one pole. Numerous other possibilities of application are conceivable and can further improve the disclosure, but they are mere details and not subject of the present patent application.

If the guide roller used for implementing the present disclosure is arranged at a ground station, the mechanical and electrical units of the disclosure are particularly easy to access. In this case, it is also especially easy to position the sensor directly before the winder.

Preferably, the guide roller is the last guide roller before the winder in the machine direction.

In a second aspect of the present disclosure, the task is solved by a method for operation an installation for producing a film web by means of a die from a plastic melt provided by an extruder and for winding up the film web to a film roll at a winder, the installation being adapted for guiding the film web on its path along a machine direction from the die to the winder around a guide roller and to finally wind it up on the film roll at the winder, the installation having a control circuit with a controller, a sensor and an actuator and the sensor determining a measure for the flatness and the controller actuating the actuator using the measure for flatness in order to improve flatness.

The terminology of the second aspect of the present disclosure has already been explained above with reference to the first aspect of the disclosure.

Preferably, the sensor is adapted to register a roll-off edge of the film web at the guide roller, whereto the controller receives data from the sensor via a data connection, performs a comparison with these data and actuates the actuator via a data connection with desired values or with previous actual values, depending on the results of the comparison, so as to adjust a heating means and/or a longitudinal stretching unit in the path from the die to the winder.

Here as well, however, it is explicitly pointed out that additionally or alternatively, means different from a heating means and/or a longitudinal stretching unit can also be used for adapting the flatness.

With the introduced method, it is also possible to integrate a sensor for detecting the quality of the flatness into a blown-film plant or a different kind of film-manufacturing installation and to evaluate the flatness of the film web already during production, thus setting optimum conditions automatically, if possible.

This obviates production with empirically set values, the subjective evaluation of flatness quality and subsequent correction of the settings.

Therefore, the plant operator can reach a stable production point much faster, saving time and material.

### BRIEF DESCRIPTION OF THE DRAWING

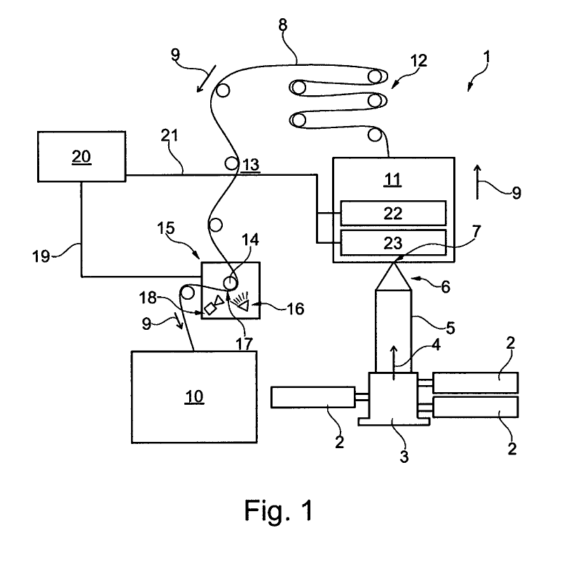

In the following, the disclosure will be explained in more detail by means of an example of embodiment with reference to the drawing wherein FIG. 1 schematically shows the structure of a blown-film plant.

### DETAILED DESCRIPTION OF THE DRAWING

The blown-film plant 1 in FIG. 1 substantially comprises three extruders 2 feeding a blowing head 3 with plastic melt which has been produced in the extruders 2 from plastic granulate.

The blowing head 3 blows out a film tubing 5 in an extruding direction 4, in this case, vertically upward, from a ring-shaped die. After passing through a lay-flat device 6, the film tubing 5 passes through a take-off roller pair 7 (not shown in detail).

Then the film tubing 5 is transferred in two layers in the machine direction 9 up to a winder 10 as a laid-flat endless film web 8.

In the path from the take-off device, which is defined by the take-off roller pair 7, to the winder 10 the film web 8 first passes through a longitudinal stretching unit 11 according to the patent application WO 2014/023282 A1 by the present applicant.

Above that, the film web 8 passes through a reversing unit 12, and then through a path 13 leading downward towards the winder 10.

Close before the winder 10, in this case, at the penultimate guide roller 14 before the winder 10, an optically delimitated inspection space 15 is crossed.

The inspection space 15 contains, on the circulating face of the guide roller 14, a lamp 16 directed towards the guide roller 14.

The film web 8 passes around the guide roller 14, detaches itself from the surface of the guide roller 14 at a roll-off edge 17 (not shown in detail) and continues in the machine direction 9.

A camera 18, in this case, a CCD camera or a different type of camera which transmits digital images, is directed at the roll-off edge 17.

The image data of the camera 18 are transferred via a first data connection 19 to a controller in a central controlling unit 20. The controller compares the measured values of the camera 18 with predefined desired values or with the actual values determined previously, where deviations of the roll-off edge 17 from an ideal straight line are evaluated by the controller so that the controller can make deductions about elevations in the film.

As soon as the controller detects deviations, it actuates a temperature control actuator 22 and/or a mechanical control actuator 23 via a second data connection 21.

The longitudinal stretching unit 11 consequently alters the film web 8 mechanically. For this purpose, the thick spots in the film web 8, which were previously detected by the camera 18, are reduced or even completely eliminated. In case this should result in new thick spots, these will also be detected automatically by the camera 18 as a consequence of variations in the roll-off edge 17, will be recognized as such by the controller in the controlling unit and also reduced or eliminated by means of a controlling intervention via the second data connection 21.

By means of iteration, the plant can thus achieve an optimum production.

The time needed for iteration is only the duration needed for reaching a new steady state as well as the time for the passage along the machine direction 9 from the exit from the longitudinal stretching unit 11 to detachment from the guide roller 14.

Temperature and stretching rate, which are two particularly important settings for the film quality, can now be set automatically. Thus, all subjective criteria used in producing the film are no longer needed.

1. An installation for manufacturing a film web by means of a die from a plastic melt provided by an extruder and for winding up the film web to a film roll by means of a winder, the installation configured to guide the film web on its path along a machine direction from the die to the winder around a guide roller and finally to wind it up onto the film roll at the winder,
the installation comprising a control circuit with a controller, a sensor and an actuator,
wherein
the sensor is adapted to determine a measure for the flatness of the film web, and
the controller is adapted to actuate the actuator using the measure of the flatness in order to improve the flatness of the film web.

2. The installation according to claim 1, wherein the installation has a second control circuit with a sensor which is adapted to determine a measure of a deviation of the thickness profile, and with a controller adapted to actuate an actuator using the measure of the deviation of the thickness profile in order to improve the deviation of the thickness profile.

3. The installation according to claim 1, wherein the controller is data-connected to the actuator.

4. The installation according to claim 1, wherein the controller is connected to the actuator by motor current.

5. The installation according to claim 1, wherein the actuator is adapted to actuate a heating means or a longitudinal stretching unit in the path from the die to the winder.

6. The installation according to claim 1, wherein the sensor is adapted to detect a roll-off edge of the film web at the guide roller, the sensor being data-connected to the controller.

7. The installation according to claim 1, wherein the installation is embodied as a blown-film plant, with the die being a ring-shaped die and a lay-flat device and a take-off device being provided in the path from the ring-shaped die to the winder.

8. The installation according to claim 7, wherein the sensor is arranged in the path from the ring-shaped die to the winder externally to the lay-flat device.

9. The installation according to claim 8, wherein the sensor is arranged in the path from the ring-shaped die to the winder externally to the take-off device.

10. The installation according to claim 7, wherein a longitudinal stretching device is arranged in the path from the ring-shaped die to the winder between the take-off device and the sensor.

11. The installation according to claim 1, wherein the installation is embodied as a flat-film plant, wherein the die is a flat-film die and in the path from the flat-film die to the winder a chill roll is arranged first, the flat-film die extruding the film onto the chill roll.

12. The installation according to claim 1, wherein in the machine direction before the sensor, a charging device for applying an electrostatic charge between the film web and the guide roller is arranged so that with the charging device switched on during operation of the installation, the roll-off edge of the film web moves downward from the guide roller and varies in height.

13. The installation according to claim 1, wherein the guide roller is arranged at a ground station.

14. The installation according to claim 1, wherein the guide roller is the last guide roller before the winder in the machine direction.

15. A method for operating an installation for producing a film web by means of a die from a plastic melt provided by an extruder and for winding up the film web to a film roll on a winder, including the steps of adapting the installation to guide the film web on its path along a machine direction from the die to the winder around a guide roller and wind it up onto the film roll at the winder,
the installation having a control circuit with a controller, a sensor and an actuator,
wherein
the sensor determines a measure for the flatness of the film web, and
the controller actuates the actuator using the measure for the flatness so as to improve the flatness of the film web.

16. The method according to claim 15, wherein the sensor is adapted to detect a roll-off edge of the film web at the guide roller, wherein the controller receives data from the sensor via a data connection, the controller performs a comparison and, based on the results of the comparison, the controller actuates the actuator via a data connection in order to adjust a heating means or a longitudinal stretching unit in the path from the die to the winder.
